(19) United States
(12) Patent Application Publication
(10) Pub. No.: US 2020/0269657 A1
(43) Pub. Date: Aug. 27, 2020

(54) VEHICLE INDUCTION HEATER

(71) Applicant: Hanon Systems, Daejeon (KR)

(72) Inventors: Jun Su KIM, Daejeon (KR); Kil Sang JANG, Jeollabuk-do (KR); Kyung Seok CHO, Jeollabuk-do (KR); Yong Ha CHAE, Gwangju (KR)

(21) Appl. No.: 16/607,615

(22) PCT Filed: Aug. 24, 2018
(86) PCT No.: PCT/KR2018/009802

§ 371 Date: Oct. 23, 2019

(30) Foreign Application Priority Data
Nov. 13, 2017 (KR) 10-2017-0150502

(51) Int. Cl. B60H 1/22; F24H 1/16; F24H 9/18

(52) U.S. Cl. CPC B60H 1/2221; F24H 1/162; F24H 2250/08; B60H 2001/2228; F24H 9/18

(57) ABSTRACT

An induction heater for a vehicle according to the present invention heats a coolant of the vehicle using an induction heating method, and more particularly, is easy to mold and has a reduced heating density by applying a plate-shaped coil and plate-shaped heating elements.

### TECHNICAL FIELD

The present invention relates to an induction heater for a vehicle that heats a coolant of the vehicle using an induction heating method, and more particularly, to an induction heater for a vehicle which is easy to mold and has a reduced heating density by applying a plate-shaped coil and plate-shaped heating elements.

### BACKGROUND ART

An internal combustion engine vehicle that uses gasoline or diesel engines as a driving source is currently the most common type of vehicle, but with respect to an energy source of such an internal combustion engine, there is an increasing need for new energy sources due to various causes such as environmental pollution caused by exhaust gas generated in combustion, as well as reduction of oil reserves, and as a result, electric vehicles (EV), hybrid vehicles (HEV), and fuel cell vehicles (FCEV), which use electricity as the energy source, are currently being put to practical use or under development.

However, unlike a conventional internal combustion engine vehicle, a heating system using a coolant may not be applied to a vehicle using electricity as the energy source or it is difficult to apply the heating system thereto. That is, the vehicle using the conventional internal combustion engine as the driving source generates a large amount of heat in the engine, has a coolant circulation system for cooling such heat, and uses heat absorbed by the coolant from the engine for indoor heating. However, since a large amount of heat such as that generated in the engine, does not occur the driving source of the electric vehicle, the hybrid vehicle, and the fuel cell vehicle, there has been a limitation in using such a conventional heating system.

Accordingly, several studies have been conducted on the electric vehicle, the hybrid vehicle, the fuel cell vehicle, and the like, and for example, a heat pump may be added to an air conditioning system to allow the heat pump to be used as a heat source, a separate heat source such as an electric heater is provided, or the like. Among them, the electric heater is now widely used because it may heat the coolant more easily without significantly affecting the air conditioning system.

Here, the electric heater includes an air heating type heater for directly heating air blown into an interior of a vehicle, and a coolant heating type heater (or a coolant heater) for heating the coolant.

Among them, the conventional induction heating type coolant heater used for the fuel cell vehicle to heat the coolant is configured so that a high frequency generator 30 is electrically connected to a fuel cell stack 10 that produces power, and is formed in the form of a coil wound on the outside of a coolant flow pipe 2 made of a metal material, which is a magnetic substance, wherein an eddy current is generated in the coolant flow pipe 2 due to a magnetic field changed when an alternating current flows through the induction coil 31 by using the power of the fuel cell stack 10 and the coolant flow pipe 2 may be heated by Joule's heat to thereby heat the coolant passing through the coolant flow pipe 2.

However, in such a conventional induction heating type coolant heater, since a heating density of a heating portion of the flow pipe 2 wound with the induction coil 31 increases, there is a risk that the heating portion of the fluid pipe 2 rapidly overheats during an operation of the high frequency generator 30, resulting in failure of the induction heater or a fire.

Therefore, a length of the heating portion of the flow pipe 2 wound with the induction coil 31 needs to be lengthened or an outer diameter needs to be increased to lower the heating density, but there is a limit in a length molding of the flow pipe 2, so that the molding may not be performed over a certain length, and when the outer diameter of the pipe is increased, a problem of deterioration of performance due to a coolant flow pressure drop occurs.

### DISCLOSURE

### Technical Problem

An object of the present invention is to provide an induction heater for a vehicle including a plate-shaped induction coil on a coolant flow path and plate-shaped heating elements on opposite sides of the induction coil, respectively, without affecting flow pressure of coolant while reducing a heating density.

Another object of the present invention is to provide an induction heater for a vehicle capable of easily removing bubbles generated in the heater by setting a height of an outlet through which coolant flows out to be higher than a level of coolant flowing in a system.

### Technical Solution

In one general aspect, an induction heater for a vehicle includes a body 100 having a heating space A2 in which coolant flows; a coil part 200 provided in the heating space A2 and including a plate-shaped coil 230 and a housing 210 in which the coil 230 is accommodated for insulation of the coil 230; and plate-shaped heating elements 310 and 320 disposed to be adjacent to the coil part 200, wherein the heating space A2 includes a first flow path R1 formed along one surface of the coil part 200 and a second flow path R2 formed along the other surface of the coil part 200.

The heating elements 310 and 320 may include a first heating element 310 disposed on one surface of the coil part 200 and a second heating element 320 disposed on the other surface of the coil part 200, and the first flow path R1 may pass through the first heating element 310 and the second flow path R2 may pass through the second heating element 320.

The induction heater 1000 for a vehicle may further include a control part 120 connected to the coil 230 and a power supplying part to connect or block power supplied to the coil 230, and controlling the heating elements 310 and 320 to be inductively heated, wherein the body 100 may have a control space A1 in which the control part 120 is accommodated, and the control space A1 and the heating space A2 may be partitioned by a partition wall 160.

Electromagnetic wave blocking bodies 311 and 312 of a plate shape formed of a soft magnetic material may be provided on one surface of the first heating element 310 or the other surface of the second heating element 320 or one surface of the first heating element 310 and the other surface of the second heating element 320, respectively.

The induction heater 1000 for a vehicle may further include an inlet for supplying the coolant to the heating space A2; and an outlet for discharging the coolant heated in the heating space A2, wherein the inlet may be formed at a position lower than the outlet, and the outlet may be formed on an upper side of the heating space A2.

The inlet and the outlet may be formed on any one surface of the body 100, the inlet may be formed on a lower side of the body 100, and the outlet may be formed on an upper side of the body 100.

The body 100 may include a second cover 520 sealing an opening part of a lower side of the heating space A2, and the inlet may be formed on the second cover 520.

When the coil part 200 is disposed along a vertical direction, the inlet may be formed on a lower side of the second cover 520, and the outlet may be formed on an upper side of the second cover 520.

The outlet may be formed to penetrate through the body 100 and may be formed to be tilted upward toward an outer side of the body 100.

An upper surface of the heating space A2 may be formed to be tilted toward an outlet side so that the outlet side is higher and a side opposing the outlet side is lower.

The control part 120 may be disposed to be in close contact with the partition wall 160.

An element 130 of the control part 120 may be disposed to be adjacent to an inlet side on the control part 120.

The coil 230 may be spaced and wound in a circular shape and may be formed in a single layer or a plurality of layers, and the coil part 200 may include a bobbin 240 to which the coil 230 is fitted to maintain a shape of the coil 230.

A power connection part 150 through which a power connection terminal 232 penetrates may be formed on the partition wall 160 so that the power connection terminal 232 of the coil 230 is connected to the control part 120.

Steps 151 may be formed on the power connection part 150, and O-rings O may be inserted into portions where the steps 151 and a power connection terminal housing 243 to which the power connection terminal 232 is fixed are in contact with each other.

### Advantageous Effects

In the induction heater for a vehicle according to the present invention having the configuration as described above, since the induction coil or the heating element is formed in the plate shape and the pair of heating elements are symmetrically disposed on the opposite sides of the induction coil, respectively, there is no limit in molding due to an increase in size, and even though the size of the coil or the heating element is increased, there is no difference in the sectional area of the coolant flow path, thereby making it possible to reduce the heating density of the heating element by increasing the size of the heating element.

In addition, since the inlet and the outlet of the coolant are freely disposed, the bubbles generated in the heater may be quickly discharged through setting of the position of the output of the coolant.

As a result, as the heating density is reduced, the failure or the fire occurrence caused by overheating of the heater may be prevented, and it is possible to reduce the possibility of bubble occurrence and quickly remove the generated bubbles, thereby preventing the deterioration of the heat exchange performance caused by the remaining bubbles in the heater.

### DESCRIPTION OF DRAWINGS

FIGS. 1 and 2 are a schematic view and a cross-sectional view illustrating the conventional coolant heater.

FIG. 3 is an overall perspective view of an induction heater according to an embodiment of the present invention.

FIG. 4 is an exploded perspective view of the induction heater according to an embodiment of the present invention.

FIG. 5 is a bottom perspective view of the induction heater according to an embodiment of the present invention.

FIG. 6 is a perspective view of a coil part of the induction heater according to an embodiment of the present invention.

FIG. 7 is an exploded perspective view of the coil part according to an embodiment of the present invention.

FIG. 8 is a cross-sectional view of the coil part according to an embodiment of the present invention.

FIG. 9 is a partially enlarged cross-sectional view of the induction heater according to an embodiment of the present invention.

FIG. 10 is a schematic cross-sectional view of an induction heater according to another embodiment of the present invention.

FIG. 11 is a schematic cross-sectional view of an induction heater disposed in a vertical direction according to still another embodiment of the present invention.

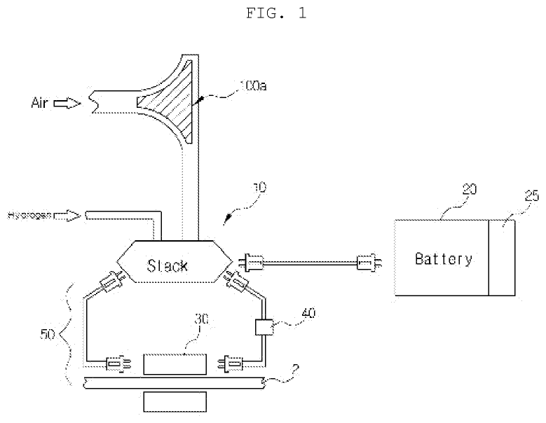

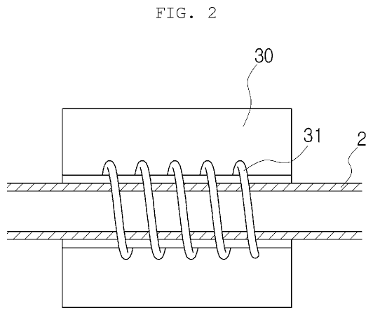

### DESCRIPTION OF REFERENCE NUMERALS

| | |
|---|---|
| 1000: induction heater | |
| A1: control space | A2: heating space |
| 100: body | 120: control part |
| 130: element | |
| 200: coil part | 210: housing |
| 220, 250: holder | 230: coil |
| 240: bobbin | |
| 310, 320: heating element | |
| 510, 520: cover | |

### Best Mode

Hereinafter, an embodiment of the present invention will be described in detail with reference to the accompanying drawings.

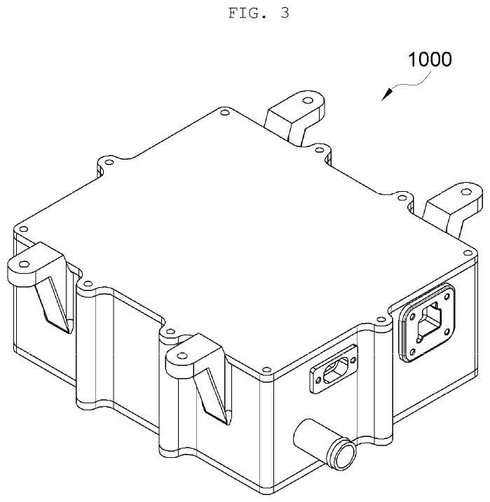

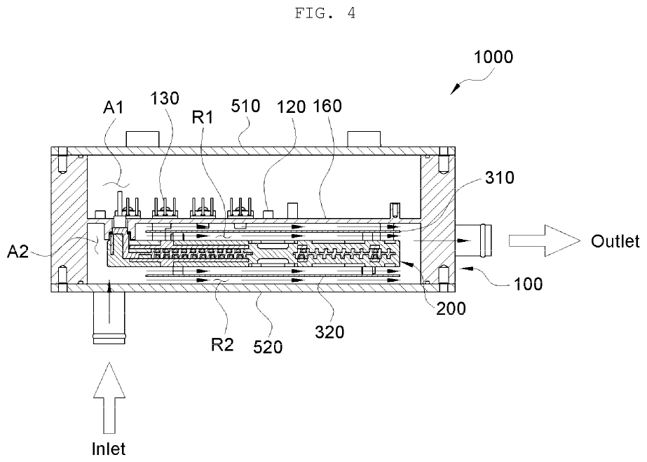

FIG. 3 illustrates an entire perspective view of an induction heater 1000 according to an embodiment of the present invention, and FIG. 4 illustrates a cross-sectional view of the induction heater 1000 according to the embodiment of the present invention.

As illustrated, the induction heater 1000 is formed in a box shape and includes a coil part 200 for generating a magnetic field by electricity and heating elements 310 and 320 inductively heated by the magnetic field. Therefore, the induction heater 1000 has a configuration in which coolant introduced into the induction heater 1000 is heated by the heating elements 310 and 320 and is discharged. In more detail, the induction heater 1000 includes a body 100 having a hollowed inner portion. The body 100 is formed to include a control space A1 in which a control part 120 is accommodated, and a heating space A2 in which the coil part 200 and the heating elements 310 and 320 are accommodated and the coolant flows, and the control space A1 and the heating space A2 are partitioned by a partition wall 160. In addition, an opening part of one side of the control space A1 may be sealed through a first cover 510, and an opening part of the other side of the heating space A2 may be sealed through a second cover 520.

The coil part 200 provided in the heating space A2 is formed in a plate shape and is disposed at the center in a vertical width direction of the heating space A2. Therefore, the coolant introduced through a coolant inlet is divided along a first flow path R1 in which the coolant flows along one surface of the coil part 200 and a second flow path R2 in which the coolant flows along the other surface of the coil part 200. The coolant flowing through the first flow path R1 is discharged to a coolant outlet via a first heating element 310, and the coolant flowing through the second flow path R2 is discharged to the coolant outlet via a second heating element 320. The heating elements 310 and 320 inductively heated by the magnetic field generated by the coil part 200 are also formed in the plate shape. The heating elements 310 and 320 includes the first heating element 310 disposed on the first flow path R1 to be adjacent to the coil part 200 and the second heating element 320 disposed on the second flow path R2 to be adjacent to the coil part 200. The first heating element 310 heats the coolant flowing along the first flow path R1 and the second heating element 320 heats the coolant flowing along the second flow path R2.

Even though a size or an area of the coil part 200 and the heating elements 310 and 320 formed in the plate shape as described above is increased, the coil part 200 and the heating elements 310 and 320 are not restricted in molding and do not affect flow pressure during coolant flow.

In addition, the control part 120 provided in the control space A1 is formed in a normal PCB shape and is tightly fixed to the partition wall 160. This is to suppress a heat generation of the control part 120 through heat exchange with the coolant flowing along the heating space A2. In particular, elements 130 of the control part 120 are components having a high heat generation and are disposed at a side on the control part 120 adjacent to the inlet to first exchange heat with the coolant which is not heated, thereby further improving a cooling performance.

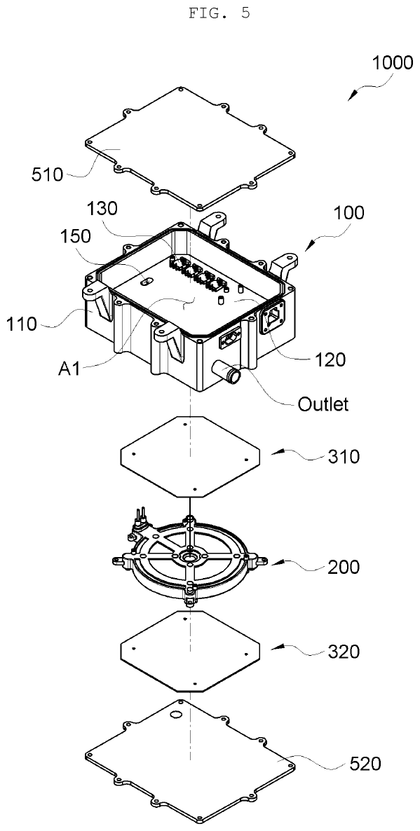

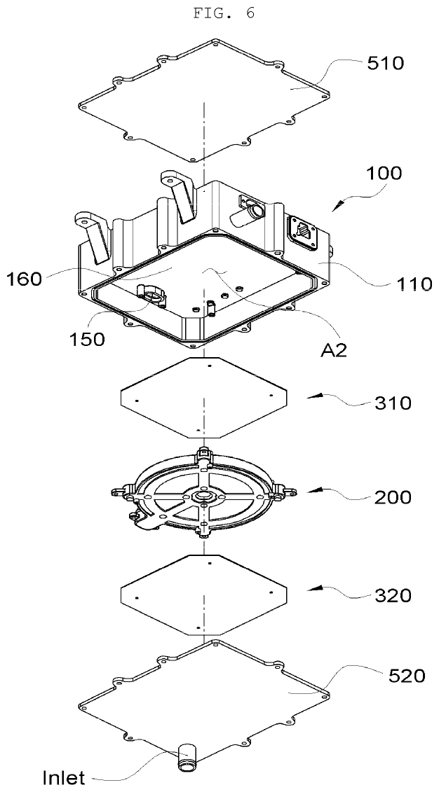

FIGS. 5 and 6 illustrate an exploded perspective view of the induction heater 1000 according to the embodiment of the present invention. For convenience, an upper side of the drawing is defined as one side and a lower side of the drawing is defined as the other side.

As illustrated, the control space A1 is formed at one side of the body 100 and the heating space A2 is formed at the other side of the body 100. The control part 120 including the elements 130 may be provided on the control space A1, and the coil part 200 and the heating elements 310 and 320 for heating the coolant may be provided in the heating space A2. In addition, a power connection part 150 may be formed on the body 100 to communicate with the control space A1 and the heating space A2 through the partition wall 160 to supply electricity to the coil part 200 through the control part 130. The induction heater 1000 includes the first cover 510 for sealing an opened surface of one side of the control space A1, and includes the second cover 520 for sealing an opened surface of the other side of the heating space A2.

An inlet for introducing the coolant is formed on the second cover 520 and an outlet for discharging the heated coolant is formed on a side surface of the body 100 of the heating space A2 side.

In addition, the coil part 200 is formed in a circular plate shape as illustrated, and the heating elements 310 and 320 disposed to be adjacent to one surface and the other surface of the coil part 200 are also formed in a plate shape having a predetermined thickness.

Hereinafter, a detailed configuration of the coil part 200 for inductively heating the plate-shaped heating elements 310 and 320 as described above will be described in detail with reference to the accompanying drawings.

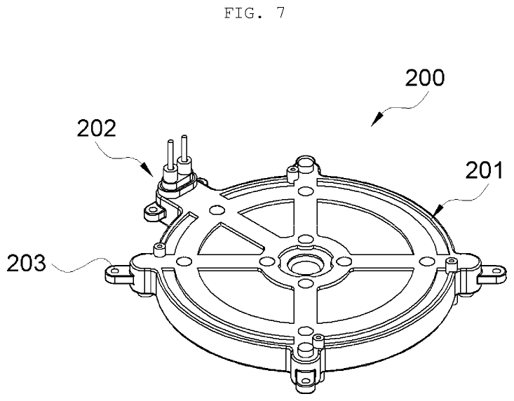

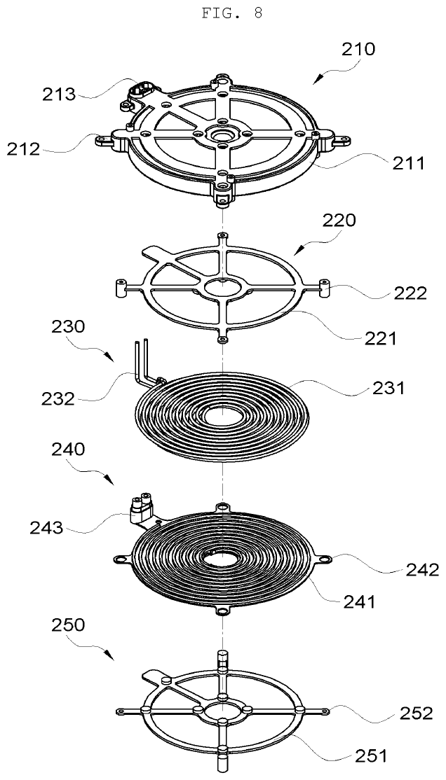

FIG. 7 illustrates an entire perspective view of the coil part 200 according to an embodiment of the present invention and FIG. 8 illustrates an exploded perspective view of the coil part 200 according to an embodiment of the present invention.

As illustrated, the coil part 200 generally includes a disc-shaped coil body 201 in which a coil 230 is accommodated, a power supplying part 202 having a power connection terminal 232 of the coil 230 exposed to supply power to the coil 230, and fixing parts 203 protruding in an outer diameter direction of the body to fix the coil part 200 to the body 100.

As the coil part 200 accommodates the coil 230 and is disposed in the heating space A2 in which the coolant flows, the coil part 200 includes a housing 210 formed of a resin material for insulating the coil 230 from the coolant, a bobbin 240 to which the coil 230 is wound and fixed in a circular shape, and holders 220 and 250 for fixing the coil 230 to the inside of the housing 210.

The housing 210 is configured to include a housing body 211 accommodating the coil 230, the bobbin 240, and the holders 220 and 250 therein, a housing power supplying part 213 from which the power connection terminal 232 of the coil 230 is exposed, and housing fixing parts 212 for fixing the coil part 200 to the body 100.

The coil 230 is configured to include a plate-shaped coil body 231 wound in a circular shape and the power connection terminal 232 formed at an end portion of the coil body 231 to receive the power. The coil body 231 may be formed in a single layer, or may be formed in the form in which a plurality of layers are wound, if necessary.

The bobbin 240 serves as a partition for fixing the wound coil 230 and includes a bobbin body 241 into which the coil body 230 is fitted, a bobbin fixing part 242 for fixing the bobbing 240 in the housing, and a power connection terminal housing 243 to which the power connection terminal 232 is fixed.

The holders 220 and 250 are configured to stably fix and support the coil 230 and the bobbin 240 inside the housing 210 and include a first holder 220 fixed to one side of the bobbin 240 and a second holder 250 fixed to the other side of the bobbin 240. The holders 220 and 250 include holder bodies 221 and 251 supporting the bobbing 240 and the holder fixing parts 252 protruding in an outer diameter direction of the holder bodies 221 and 251 to fix the holders 220 and 250 to the housing 210.

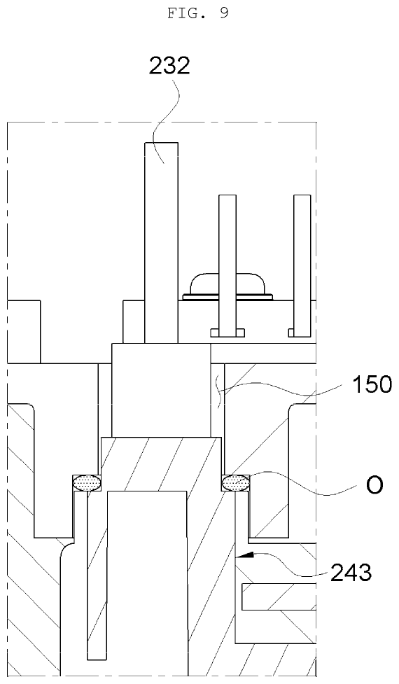

FIG. 9 illustrates a partially enlarged cross-sectional view of the induction heater 1000 according to the embodiment of the present invention. In the induction heater 1000 according to the embodiment of the present invention, the power connection terminal housing 243 and the power connection terminal 232 of the coil part 200 are formed to penetrate through the power connection part 150 of the partition wall 160. Accordingly, steps 151 are formed on the power connection part 150 to prevent the coolant in the heating space A2 from being leaked to the control space A1, and O-rings O are inserted into portions where the steps 151 and the power connection terminal housing 243 are in contact with each other to prevent the leakage of the coolant.

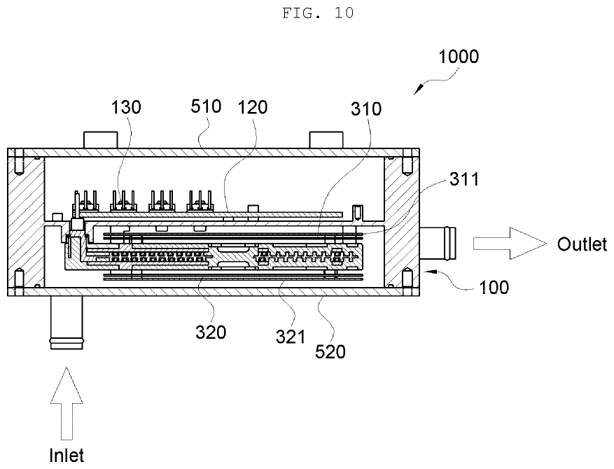

FIG. 10 illustrates a schematic cross-sectional view of an induction heater 1000 according to another embodiment of the present invention. As illustrated, a first electromagnetic wave blocking body 311 of a plate shape is provided on one side of the first heating element 310. As the first electromagnetic wave blocking body 311 is formed of a soft magnetic material and blocks and reflects a magnetic field generated in the coil part 200, there is an effect that an inductance of the first heating element 310 is increased and efficiency of induction heating may be improved even at a low frequency. In addition, there is an effect that a malfunction of the control part 120 may be prevented due to an effect of blocking the electromagnetic wave transferred to the control part 120.

As a second electromagnetic wave blocking body 321 having the same characteristics as the first electromagnetic wave blocking body 311 is also provided on the other side of the second heating element 320, there is an effect that an inductance of the second heating element 320 may be increased and the efficiency of induction heating may be improved at the low frequency as described above.

Meanwhile, the induction heater 1000 according to the present invention has the following configuration in order to increase fluidity of the coolant and to effectively remove bubbles which may be generated in the heating space A2. In the induction heater 1000 according to the present invention, the inlet may be formed on the second cover 520 positioned on the lower surface of the body 100 to move the coolant from a lower side to an upper side and move the coolant in a unidirectional direction. As another example, the inlet may be formed on the lowermost side surface of the body 100. In addition, the outlet may be formed on the uppermost side surface of the body 100. In particular, the inlet and the output may be formed on surfaces of the body 100 opposing each other, respectively, or may be formed to be maximally spaced apart from each other.

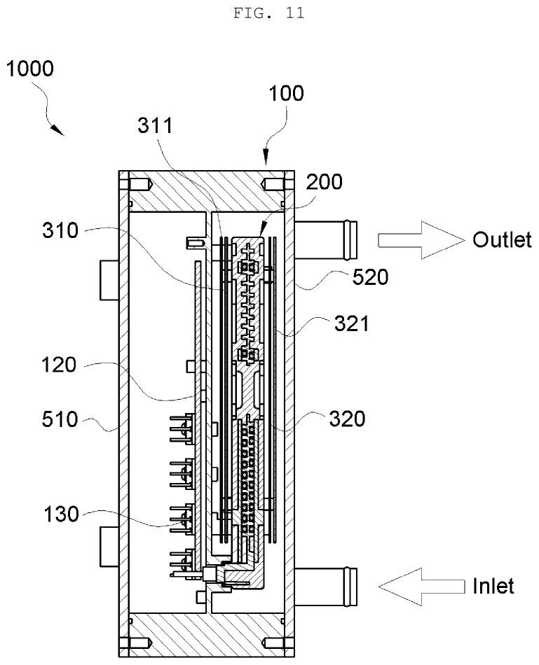

FIG. 11 illustrates a schematic cross-sectional view of an induction heater 1000 according to another embodiment of the present invention. As illustrated, when the induction heater 1000 is erected in a vertical direction, the induction heater 1000 has the following configuration in order to effectively remove bubbles which may be generated in the heating space A2. That is, the inlet is formed on the second cover 520 positioned on the lower surface of the body 100 and may be formed on the lowermost side of the second cover 520. As another example, the inlet may be formed on the side surface of the body 100. In addition, it is most preferable that the outlet is formed on the side surface of the body 100, but in order to increase space utilization, the outlet is formed on the second cover 520 positioned on the lower surface of the body 100 and may be formed on the uppermost side of the second cover 520.

Additionally, although not illustrated in the drawings, the outlet may be formed to penetrate through the body 100 and be outwardly extended, and may be formed to be tilted upward toward an outer side of the body 100. As described above, as the outlet is formed to be tilted upward, the induction heater is configured so that the bubbles moved toward the outlet side may be more easily discharged. In addition, an upper surface of the heating space A2 may also be formed to be tilted toward the outlet side. That is, as the outlet side is formed to be higher and a side opposing the outlet side is formed to be lower, the induction heater is configured so that the bubbles generated on the upper side of the heating space A2 may be guided to the outlet side.

The present invention is not to be construed as being limited to the above-mentioned embodiment. The present invention may be applied to various fields and may be variously modified by those skilled in the art without departing from the scope of the present invention claimed in the claims. Therefore, it is obvious to those skilled in the art that these alterations and modifications fall in the scope of the present invention.

1. An induction heater for a vehicle, comprising:
a body having a heating space in which coolant flows;
a coil part provided in the heating space and including a plate-shaped coil and a housing in which the coil is accommodated for insulation of the coil; and
plate-shaped heating elements disposed to be adjacent to the coil part,
wherein the heating space includes a first flow path formed along one surface of the coil part and a second flow path formed along the other surface of the coil part.

2. The induction heater for a vehicle of claim 1, wherein the heating elements include a first heating element disposed on one surface of the coil part and a second heating element disposed on the other surface of the coil part, and
the first flow path passes through the first heating element and the second flow path passes through the second heating element.

3. The induction heater for a vehicle of claim 1, further comprising a control part connected to the coil and a power supplying part to connect or block power supplied to the coil, and controlling the heating elements to be inductively heated,
wherein the body has a control space in which the control part is accommodated, and
the control space and the heating space are partitioned by a partition wall.

4. The induction heater for a vehicle of claim 2, wherein electromagnetic wave blocking bodies of a plate shape formed of a soft magnetic material are provided on one surface of the first heating element or the other surface of the second heating element or one surface of the first heating element and the other surface of the second heating element, respectively.

5. The induction heater for a vehicle of claim 1, further comprising:
an inlet for supplying the coolant to the heating space; and
an outlet for discharging the coolant heated in the heating space,
wherein the inlet is formed at a position lower than the outlet, and
the outlet is formed on the uppermost side of the heating space.

6. The induction heater for a vehicle of claim 5, wherein the inlet and the outlet are formed on any one surface of the body, the inlet being formed on a lower side of the body and the outlet being formed on an upper side of the body.

7. The induction heater for a vehicle of claim 6, wherein the body includes a second cover sealing an opening part of a lower side of the heating space, and the inlet is formed on the second cover.

8. The induction heater for a vehicle of claim 7, wherein when the coil part is disposed along a vertical direction, the inlet is formed on a lower side of the second cover, and the outlet is formed on an upper side of the second cover.

9. The induction heater for a vehicle of claim 5, wherein the outlet is formed to penetrate through the body and is formed to be tilted upward toward an outer side of the body.

10. The induction heater for a vehicle of claim 5, wherein an upper surface of the heating space is formed to be tilted toward an outlet side so that the outlet side is higher and a side opposing the outlet side is lower.

11. The induction heater for a vehicle of claim 3, wherein the control part is disposed to be in close contact with the partition wall.

12. The induction heater for a vehicle of claim 11, wherein an element of the control part is disposed to be adjacent to an inlet side on the control part.

13. The induction heater for a vehicle of claim 1, wherein the coil is spaced and wound in a circular shape and is formed in a single layer or a plurality of layers, and
the coil part includes a bobbin to which the coil is fitted to maintain a shape of the coil.

14. The induction heater for a vehicle of claim 3, wherein a power connection part through which a power connection terminal penetrates is formed on the partition wall so that the power connection terminal of the coil is connected to the control part.

15. The induction heater for a vehicle of claim 14, wherein steps are formed on the power connection part, and
O-rings are inserted into portions where the steps and a power connection terminal housing to which the power connection terminal is fixed are in contact with each other.
